(19) United States
(12) Patent Application Publication
(10) Pub. No.: US 2010/0209695 A1
(43) Pub. Date: Aug. 19, 2010

(54) Artificial marble containing chip with transparent and light reflecting materials, and process for preparing the same

(75) Inventor: Yang-Hwan Cho, Daegu (KR)

Correspondence Address: LGCHEM;Lerner, David, Littenberg, Krumholz & Mentlik, LLP, 600 South Avenue West, Westfield, NJ, 07090, US

(73) Assignee: LG Chem ,Ltd.,, Seoul (KR)

(21) Appl. No.: 12/308,322

(22) PCT Filed: Dec. 14, 2006
(86) PCT No.: PCT/KR2006/005455

§ 371 Date: Dec. 10, 2008

(30) Foreign Application Priority Data
Jun. 13, 2006 (KR) 10-2006-0052801
Jun. 22, 2006 (KR) 10-2006-0056353

(51) Int. Cl. B32B 5/16; B32B 38/00; C04B 26/06; B32B 38/10

(52) U.S. Cl. 428/323; 428/402; 156/222; 156/154

(57) ABSTRACT

Disclosed herein are high specific gravity light reflecting chips capable of exhibiting a depth feeling and glittering, and a method for producing the chips and an artificial marble comprising the chips. The high specific gravity light reflecting chips for an artificial marble consists of a high specific gravity layer, a low specific gravity layer, and a light reflecting layer comprising a light reflective material laminated in this order from the top. Disclosed also are an artificial marble comprising light reflecting transparent chips composed of transparent materials and light reflective materials, and a method producing the artificial marble. The artificial marble comprises light reflecting transparent chips consisting of a transparent layer to be exposed to the outside from the surface of the artificial marble, and a light reflecting layer laminated under thereof.

### TECHNICAL FIELD

The present invention relates to an artificial marble and chips for the artificial marble. More specifically, the present invention relates to high specific gravity chips which enable a use of a low specific gravity material in the form of a chip and exhibition of light reflection with a depth feeling, a method for producing the chips, and an artificial marble with the chips. More particularly, the present invention relates to an artificial marble and chips for the artificial marble, wherein a high specific gravity layer is introduced into chips, the specific gravity of the chips is allowed to be similar to that of a base resin, and the overall chips are uniformly distributed ranging from the upper side and to the lower side, thereby preventing non-uniform distribution of the chips resulting from the use of a low specific gravity material alone, due to a relatively low specific gravity of the chips, as compared to that of the base resin of an artificial marble.

In addition, the present invention relates to an artificial marble and a method for producing the artificial marble, wherein a high specific gravity material is introduced into chips in the form of an integral structure for utilization of a transparent low specific gravity material as chips, and the chips are used in production of an artificial marble, thereby exhibiting a deep-transparence feeling and light refection effect via the chips contained in the artificial marble.

### BACKGROUND ART

General artificial marbles produced with an acrylic resin have been used in various applications including sinks, counter desks, tables, decorative goods, etc., owing to their advantages of graceful appearance and excellent workability, and high strength relative to light-weight over natural marbles. However, acrylic artificial marbles have technical limitations in expressing various patterns utilizing simple combinations of opaque chips commonly used in the art, when compared to natural marbles and granite.

An acrylic and unsaturated ester-based artificial marble is commonly produced by mixing an inorganic filler having a high specific gravity, e.g., aluminum hydroxide, calcium carbonate, silica and silicon with a syrup of a monomer, e.g., methyl methacrylate (MMA), and a polymer of polymethyl methacrylate (PMMA) or unsaturated polyester (UPE) as a main constituent, adding a pigment and various additives e.g., a polymerization initiator agent, a crosslinking agent, a chain transferring agent, and a coupling agent to the mixed compound, molding the mixture in a mold or a continuous steel belt, and curing the molded mixture.

Pigments and chips are mainly used to provide colors and shapes to artificial marbles. Polymethyl methacrylate (PMMA) used currently in the art may be used as a main constituent of these chips. If necessary, a thermoplastic resin such as polyvinyl chloride (PVC) and polystyrene (PS), or a thermosetting resin such as epoxy and unsaturated polyester may be used. Chips for an artificial marble are produced by adding various additives, or a mixture of at least one pigment and various additives, to the resin, producing a flat board by the method equal or similar to those commonly used in production of artificial marbles, and crushing the final artificial marbles to have various particle sizes.

To impart a glittering property upon exposure to light to artificial marbles (e.g., engineered stones), there has been currently used a method of mixing a material (e.g., pearls) with a base resin, or using a metal (e.g., aluminum)-transferred material as chips. There has been suggested a method for using a mirror to realize a depth feeling and light reflection effect. However, the method is not enough to obtain a desired effect.

When acrylic or unsaturated polyester (UPE) resin-based artificial marbles are produced by using a material such as metals or mirrors, they cannot be grinded due to a high specific gravity of the material, and are hardly usable due to their poor processability. On the other hand, when the chips are produced by using a low specific gravity material, they contain an inorganic filler, thus involving disadvantageous deterioration in transparency and not being enough to obtain a desired effect.

The chips produced by using such materials as metals, pearls and glass flakes exhibit the materials on the surface of the final artificial marble, thus having a limitation in realization of a depth feeling.

Korean Patent Laid-open No. 2004-0059913 discloses an acrylic-based artificial marble featuring the use of chip-in-chip. However, the disclosed acrylic artificial marble has a problem of deterioration in transparency because of an inorganic filler contained in a composition thereof, and a limitation in realization of a depth feeling due to a glittering material arranged on the surface of the final artificial marble.

Korean Utility Model Registration No. 400,814 discloses an artificial marble featuring the formation of chip-in-chip wherein unsaturated polyester-based particles are stuck into an acrylic resin syrup-cured matrix to form patterned marble chips, and a glittering material is stuck into the unsaturated polyester-based particles. However, the artificial marble has a poor transparency because of an inorganic filler contained in a composition thereof, and a poor depth feeling due to the transparent material exposed to the surface thereof.

Japanese Patent Publication No. 2001-205750 discloses an artificial marble molded article including a transparent gel coat layer, an artificial marble layer, and an intermediate layer containing a gloss pigment interposed between the two layers. The artificial marble is obtained by simply coating a gloss layer and transparent layer on the surface thereof, and is thus not directly related to the utilization of a low specific gravity material based on the high specific gravity chips, which is a feature of the present invention.

Japanese Patent No. 3,648,592 discloses an artificial marble using a variety of chips having different specific gravity and shapes. The artificial marble is not directly related to the utilization of a low specific gravity material based on the high specific gravity chips, and light reflecting effect, which are features of the present invention.

Japanese Patent Publication No. 1999-314942 discloses glass powders colored with at least one compound selected from transition metals and rare earth metals while crystallizing 0.1 to 20 wt % of plastic glass powder. This invention merely provides colored-glass powders for use as a filler of an artificial marble, and is not directly related to the utilization of a low specific gravity material based on the high specific gravity chips, and light reflecting effect, which are features of the present invention.

Japanese Patent Publication No. 1995-2556 discloses a resin composition for an artificial marble. The resin composition is prepared by mixing a filler with a unsaturated polyester resin comprising an unsaturated polyester and polymeric monomer. The filler consists of 1 to 30% by weight of luminance capability filler whose main constituent is a titanium oxide-coated mica powder, and 70 to 99% by weight of an inorganic filler. The invention merely relates to the filler, and is not directly related to the utilization of a low specific gravity material based on the high specific gravity chips, and light reflecting effect, which are features of the present invention.

### DISCLOSURE

### Technical Problem

Therefore, it is one object of the present invention to apply a low specific gravity material to an artificial marble.

It is another object of the present invention to impart a light reflecting effect with a deep-transparence feeling as well as glitter effect to an artificial marble, thereby showing substantially the same texture and luster as natural marbles.

It is yet another object of the present invention to provide an artificial marble and a method for producing the artificial marble, wherein a high specific gravity material is introduced into chips in the form of an integral structure for utilization of a transparent low specific gravity material as chips, and the chips are used in production of an artificial marble, thereby exhibiting a deep-transparence feeling and light refection effect via the chips contained in the artificial marble.

### Technical Solution

In accordance with one aspect of the present invention, there is provided high specific gravity light reflecting chips consisting of a high specific gravity layer, a low specific gravity layer, and a light reflecting layer comprising a light reflective material laminated in this order from the top, wherein the low specific gravity layer has a specific gravity lower than that of the artificial marble, the high specific gravity layer has a specific gravity higher than that of the artificial marble, and the light reflecting layer contains a light reflective material.

The present invention suggests producing chips capable of exhibiting a glittering effect by transfer or deposition of metals, or coating of pearls or glass flakes, etc., on a low specific gravity transparent layer, and integrally forming the low specific gravity transparent layer with a specific gravity regulating layer containing a high specific gravity filler, thereby solving the difference in specific gravity between the chips and the artificial marble using the same.

According to the present invention, the difference in specific gravity between the high specific gravity light reflecting chips and a material composition of the artificial marble using the chips is not more than 0.5, and preferably, not more than 0.2.

The present invention has a feature of minimizing the difference in specific gravity between the high specific gravity chips and the material composition of the artificial marble using the same. When the high specific gravity chips and the material composition have no specific gravity difference, i.e. have the same specific gravity as each other, or the specific gravity difference is not more than 0.2, there is no separation of the chips from the material composition.

The inventors of the present invention had attempted to introduce a transparent low specific gravity material (e.g., an acrylic resin) into a material composition of an artificial marble, in order to realize an artificial marble close to natural stones in view of a pattern and color by achieving a high transparency equivalent to that of high-purity silica and quartz contained in natural stones. However, they have avoided adding fillers to the material composition in order to maintain the transparency of the low specific gravity material, thus disadvantageously causing separation of chips due to the difference in specific gravity, when the low specific gravity material in the form of a chip is introduced into the artificial marble.

Generally, a polymer resin is a low specific gravity material having a specific gravity of 1.5 or less. For example, a transparent acrylic resin, such as poly-methylmethacrylate (PMMA), has a specific gravity ranging from about 1.17 to about 1.20. However, the material composition of the artificial marble generally has a specific gravity of 1.4 to 1.8.

Due to the difference in specific gravity between the transparent resin and the material composition of the artificial marble, when transparent chips made of the transparent resin are introduced into the artificial marble, the transparent chips may suffer from separation from the artificial marble. There is no transparent polymer having a high specific gravity of 1.5 or more. For this reason, to date, there has been no artificial marble using transparent chips produced with a polymer resin alone.

In the present invention, by realizing relatively high specific gravity chips containing a transparent low specific gravity material, it is possible to minimize the difference in specific gravity between the chips and the material composition of the artificial marble, thereby imparting a natural quartz-like texture to artificial marble products without the risk of separation of the transparent low specific gravity material.

Preferably, the total specific gravity of the high specific gravity chips may be in the range of 1.0 to 2.0, and more particularly, 1.4 to 1.8, which is similar to that of the material composition of artificial marbles. To allow the high specific gravity chips to have a specific gravity within the range defined above, the high specific gravity layer preferably has a specific gravity ranging from 1.5 to 10, and more particularly, from 2.0 to 8.0. Also, the low specific gravity layer may have a specific gravity ranging from 0.1 to 2.0, preferably, 1.5 or less.

The low specific gravity layer may be a transparent layer having a light transmissivity of 70 to 100%, and preferably, 95% or more. Conventional chips contain fillers (e.g., aluminum hydroxide), and are semitransparent chips having a light transmissivity of 60% or less. It should be noted that a transparency effect may be increased via a regulation of thickness even under the condition of a constant light transmissivity.

A base resin that can be used for chips of the present invention may be a transparent polymer resin selected from acrylic resin, unsaturated polyester resin, epoxy resin, polyvinyl chloride (PVC), polystyrene (PS), polycarbonate (PC), polyethylene terephthalate (PET), or styrene-methylmethacrylate (SMMA) copolymer resin. Preferred is a transparent polymer resin such as polymethyl methacrylate (PMMA), polyester resin and polyethylene terephthalate (PET). In particular, the low specific gravity layer may be preferably formed of transparent acrylic chips comprising an acrylic resin as a base resin.

According to the present invention, the use of the high specific gravity layer enables direct application of transparent acrylic chips having a high light transmissivity and good physical properties, thereby achieving a natural quartz-like appearance while allowing the implementation of subsequent processes, such as casting and grinding, which could not be conventionally performed due to the difference in specific gravity.

In the present invention, the high specific gravity layer contains a filler to regulate the difference in specific gravity. Examples of suitable fillers may include barium, precipitated calcium carbonate, stone powders, silica, titanium dioxide, aluminum hydroxide, calcium carbonate, metal powders, and metal salts. The specific gravity of the filler must be at least 2.0, and preferably is in the range of 4.0 to 10. The use of a high specific gravity filler is effective in improving a specific gravity regulation effect relative to the content thereof.

The light reflecting material that can be used for the light reflecting layer of the present invention includes metals, nonmetals, pearls and glass flakes. The metals may be introduced into the layer by transfer or deposition. The pearls and glass flakes may be introduced into the layer by addition of a resin to the material.

When the light reflecting material such as metals, pearls and glass flakes is applied to an under-layer of the transparent low specific gravity layer of the present invention, it is possible to obtain a depth feeling corresponding to the thickness of the transparent low specific gravity layer. As a result, the chips of the present invention can show a higher light reflectivity, as compared to that of conventional chips restricted to the surface of the layer.

There is no restriction as to the shape of chips that can be used in the present invention. The examples of the chip shapes include a cylinder, and a polyhedron, e.g., a tetrahedron and hexahedron. Hexahedron shapes or more sided shapes are used in general.

Preferably, the size of the high specific gravity light reflecting chip is in the range of 2 to 20 mm, when taking into consideration of the factors such as appearance effects and formability. The chip is preferably used in a content of 0.1 to 50% by weight, based on the total weight of an artificial marble.

In accordance with another aspect of the present invention, there is provided a method for producing high specific gravity light reflecting chips for an artificial marble, the method comprising steps of: producing a flat board for a low specific gravity layer; laminating a flat board for a high specific gravity layer on the flat board for low specific gravity layer; laminating a flat board for a light reflecting layer under the low specific gravity layer flat board; and crushing the resulting laminate, wherein the low specific gravity layer flat board has a specific gravity lower than that of the artificial marble, and the high specific gravity layer flat board has a specific gravity higher than that of the artificial marble.

A specific gravity of the high specific gravity chips may be regulated to be equal to, or approach that of a material composition of the artificial marble by regulating the specific gravity and content of a filler to be added to the high specific gravity layer flat board.

Examples of the curing method of each flat board include casting, press, vibrator, UV curing, etc. The formation of the light reflecting layer may be carried out by transferring or depositing metals on the layer, or adding a material selected from pearls, glass flakes or a mixture thereof, to a resin, followed by coating.

In accordance with another aspect of the present invention, there is provided an artificial marble using high specific gravity light reflecting chips.

Preferably, the present invention suggests an artificial marble comprising light reflecting transparent chips consisting of a transparent layer to be exposed to the outside from the surface of the artificial marble, and a light reflecting layer under the transparent layer, by which the low specific gravity layer is transparent and the high specific gravity layer is removed by sanding.

The light reflecting transparent chips are made of a transparent and light-reflective material, thus showing transparency, depth feeling and glitter derived from light reflection. The term “depth feeling” used herein means that the inside of an artificial marble as well as the surface thereof can be exhibited due to a predetermined thickness of a transparent layer. A light reflecting material is arranged under the transparent material by coating or transfer.

The present invention suggests an artificial marble using high specific gravity light reflecting chips consisting of the high specific gravity layer having a specific gravity higher than that of the artificial marble, a low specific gravity transparent layer having a specific gravity lower than that of the artificial marble, and a light reflecting layer containing a light reflective material laminated in this order from the top, and a method for producing the artificial marble.

The present invention has one feature of transferring and depositing metals on the low specific gravity transparent layer, or coating a material selected from pearls, glass flakes, etc., on the surface of transparent low specific material to produce glittering chips, and integrally forming the low specific gravity transparent layer with a specific gravity regulating layer (i.e., a high specific gravity layer) containing a filler having a high specific gravity, thereby solving the difference in specific gravity between the chips and the artificial marble using the same. In addition, the present invention has another feature of enabling exhibition of a light reflection effect with the depth feeling derived from the transparent layer by removal of the high specific gravity layer via sanding.

The artificial marbles produced by method according to the present invention realize a characteristic appearance, owing to the transparent layer exposed to the outside from the surface by the removal of the high specific gravity layer via sanding.

The artificial marble of the present invention may be an engineered artificial marble prepared by mixing an acrylic artificial marble, an unsaturated polyester artificial marble, or natural stones, quartz, glass, mirror, inorganic fillers, etc., as main materials, with 15% or less by weight of a resin syrup, based on the total weight of the artificial marble.

In accordance with another aspect of the present invention, there is provided a method for producing an artificial marble, the method comprising the steps of: producing a flat board for a transparent layer having a specific gravity lower than that of the artificial marble; laminating a flat board for a high specific gravity layer having a specific gravity higher than that of the artificial marble on the flat board for a transparent layer; laminating a flat board for a light reflecting layer under the flat board for a transparent layer; crushing the resulting laminate to produce high specific gravity light reflecting chips; producing an artificial marble using the high specific gravity light reflecting chips; and removing the high specific gravity layer by sanding to expose the transparent layer to the outside from the surface of the artificial marble.

The present invention provides light reflecting chips contained in the transparent low specific gravity layer. The application of the chips to the artificial marble enables achievement of substantially the same appearance as natural marbles. In particular, the artificial marble product of the present invention can realize a more deep-transparence feeling, as compared to conventional products.

In production of an artificial marble according to the present invention, it may be used not only a transparent low specific gravity material, but also any material, which can achieve a glittering and reflecting effect, including pearls, glass flakes, and metals, etc., rather than inorganic fillers leading to deterioration in transparency. As a result, it is possible to obtain a high-quality artificial marble having substantially the same transparency, depth feeling and glitter as natural marbles.

When the chips made of a transparent material are contained in a variety of artificial marbles, the inside of the transparent layer can be exhibited, thus realizing a depth feeling of the artificial marbles. In addition, the arrangement of light reflecting materials under the transparent layer by coating or deposition ensures a glittering effect of the inside thereof, thus realizing an excellent appearance, i.e., a light reflection at the inside thereof, which could not be obtained in conventional artificial marbles. The method for producing the chips utilizes techniques (e.g., casting and pressing) currently used in the art, thus eliminating a necessity of additional equipment. The method of the present invention suggests a solution of the difference in specific gravity between the compound of the artificial marble product and chips, i.e., the most important problem involved in the production of an artificial marble. The general methods using a low specific gravity material only such as an acrylic or unsaturated polyester (UPE) resin having a specific gravity lower than that of the composition for artificial marble products make it impossible to obtain a desired pattern. On the other hand, the methods of the present invention allow the specific gravity of the chips to be similar to that of the compound contained in artificial marble products, thereby achieving a desired appearance.

### DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view illustrating the structure of a high specific gravity chip according to the present invention;

FIG. 2 is a cross-sectional view of an artificial marble using the high specific gravity chips according to the present invention; and

FIG. 3 is a cross-sectional view of the artificial marble shown in FIG. 2 after sanding.

### BEST MODE

The present invention will now be described with reference with the accompanying drawings in detail.

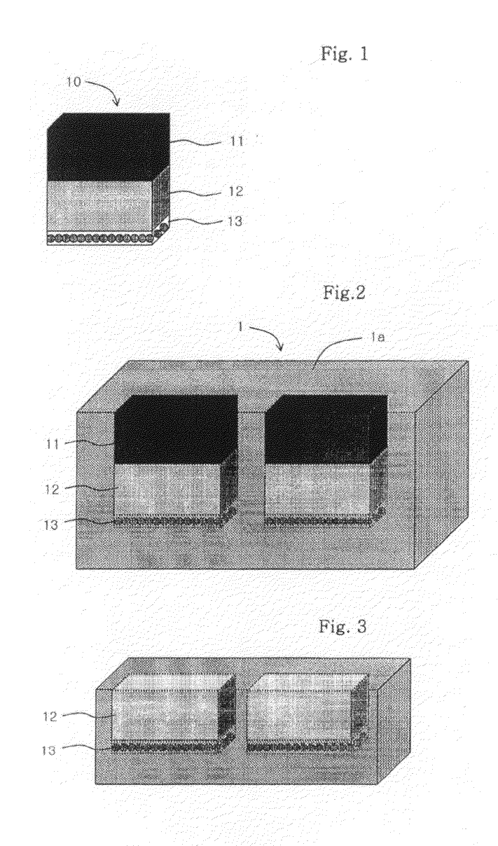

FIG. 1 shows the structure of a high specific gravity light reflecting chip according to the present invention. As shown in FIG. 1, the light reflecting chip 10 consists of a high specific gravity layer 11, a low specific gravity layer 12, and a light reflecting layer 13 laminated in this order from the top.

The light reflecting chip 10 preferably has a hexahedronal shape illustrated in FIG. 1. The examples of the chip shape include a cylinder, and a polyhedron including a tetrahedron, but are not limited thereto. In addition, the light reflecting chip 10 may be a regular or irregular shape.

The lamination of the light reflecting chip 10 preferably consists of the high specific gravity layer 11, the low specific gravity layer 12, and the light reflecting layer 13 laminated in this order, as shown in FIG. 1. When the light reflecting chip 10 has a structure of the light reflecting layer 13 laminated on the high specific gravity layer 11, the light reflecting layer 13 is exposed to the outside from the surface of artificial marbles produced therefrom. Accordingly, the transparent low specific gravity layer 12 cannot ensure a depth feeling, and is undesirable in terms of stability and contamination of light reflecting materials. Meanwhile, when the light reflecting chip 10 has a structure in which the light reflecting layer 13 is interposed between the two layers, it undergoes a deterioration in light reflectivity due to the non-transparent high specific gravity layer 11, and causes exposal of the light reflecting layer 13 to the outside from the surface of artificial marble products produced therefrom, upon removal of the non-transparent high specific gravity layer 11 by sanding.

A process for producing the light reflecting chip 10 according to the present invention comprises the steps of producing a flat board for the high specific gravity layer 11, producing a flat board for the low specific gravity layer 12 and producing a flat board for the light reflecting layer 13. The production and lamination order of each flat board are not particularly limited. The three layers may be formed without prior order.

The flat board used in production of the chips is obtained by curing a mixed compound of a polymerizable resin and an inorganic material, etc. The flat board for the low specific gravity layer 12 contains no inorganic filler.

The flat board for the low specific gravity layer 12 is produced by curing a material having a low specific gravity (in the range of 0.2 to 2.0) in the form of a flat board. Any transparent material may be used as the low specific gravity material. But, a polymer resin having a high transparency, e.g., poly-methylmethacrylate (PMMA), polycarbonate (PC) and unsaturated polyester (UPE) is preferable in view of physical properties and effects thereof. The production method of the transparent flat board is not particularly limited.

When the low specific gravity layer 12 is made of the transparent resin, it becomes the back of products (the side being in contact with a still belt is the surface of products, and the opposite side is the back of products) upon curing due to the large difference in specific gravity between the low specific gravity layer 12 and a base resin of artificial marble. As a result, the products disadvantageously involve considerably-reduced efficiency. To overcome the disadvantage, the flat board for the low specific gravity layer 12 is integrally formed with the high specific gravity layer 11 made of a high specific gravity filler.

The flat board for the high specific gravity layer 11 is prepared by curing a flat board-shaped slurry consisting of 100 parts by weight of a base resin syrup, 10 to 1,000 parts by weight of an inorganic filler, 0.1 to 10 parts by weight of a cross-linking agent, 0.1 to 10 parts by weight of a polymerization initiator, and 0.1 to 10 parts by weight of a pigment.

The inorganic filler used for the high specific gravity layer 11 is a high specific gravity material (having a specific gravity of 2.0 or more), such as barium, precipitated calcium carbonate, stone powder, silica powder, etc.

Each of the high and low specific gravity layers may take the form of a multilayer including two or more layers. Any curing method of each flat board may be used without any particular limitation so long as it is commonly used in the art. Examples of the curing method include casting, press, vibrator, UV curing, etc.

The formation of the light reflecting layer 13 is carried out by applying a material capable of imparting a glittering or light reflection effect to the cured low specific gravity layer low flat board. The application is conducted by mixing a material selected from pearls and glass flakes with a resin and coating the mixture on the layer, followed by curing, or by transferring or depositing metals and the like on the layer.

After production and lamination of each flat board, the resulting laminate is crushed to produce a high specific gravity light reflecting chip 10. Upon crushing of the chip into particles of a predetermined size, thickness of each of the low and high specific gravity layers can be controlled so that the two layers do not separate from each other.

The interaction of the three layers contributes to exhibiting a depth feeling and a glitter, and solving a problem associated with a specific gravity upon their application to artificial marble products.

The high specific gravity light reflecting chip 10 of the present invention utilizes a transparent material having a low specific gravity. Since the low specific gravity layer consists of a transparent material having a low specific gravity, without any inorganic filler, it can maintain a high transparency. In addition, the low specific gravity layer contains a light reflecting material, thereby creating a harmony of a high transparency, a depth feeling and glitter, and showing an overall high-grade appearance.

FIG. 2 is a cross-sectional view illustrating an artificial marble obtained by using a high specific gravity light reflecting chip according to the present invention. FIG. 3 is a cross-sectional view illustrating an artificial marble of FIG. 2 after sanding. As shown in FIG. 3, the flat board for artificial marble is produced by using the light reflecting chip 10, and the high specific gravity layer 11 is then removed to allow the transparent layer 12 to be exposed to the outside from the surface of the artificial marble product. As can be seen from FIG. 3, the removal of the high specific gravity layer 11 allows the final product to be in the form of a transparent and light reflecting chip consisting of the transparent layer 12 and the light reflecting layer 13.

The present invention will be better understood from the following examples. These examples are not to be construed as limiting the scope of the invention.

### EXAMPLES

A flat board for a transparent low specific gravity layer was produced by using an acrylic resin (specific gravity: 1.19, light transmissivity: 95%). Then, a flat board for a high specific gravity layer (specific gravity: 3.175) was produced by using a slurry containing 100 parts by weight of an acrylic resin and 150 parts by weight of barium sulfate as a high specific gravity filler (specific gravity: 4.499). Subsequently, the high specific gravity layer flat board was laminated on the transparent low specific gravity layer flat board. A flat board for a light reflecting layer was prepared by using a pearl pigment. Then, the light reflecting layer flat board was laminated under the transparent flat board. The resulting laminate was crushed to produce high specific gravity light reflecting chips.

The specific gravity of the produced high specific gravity chips was 1.6. The chips were used in a content of 20% by weight in production of an artificial marble. As a result, good artificial marble products having no risk of separation between the two layers due to the difference in specific gravity (±0.2) could be obtained. The resulting products are subjected to sanding to allow the transparent layer to be exposed to the outside from the surface of the artificial marble products, thus showing a high-grade image with glitter effects.

### INDUSTRIAL APPLICABILITY

As apparent from the above description, in the methods of the present invention, since the chips made of a transparent material are contained in a variety of artificial marbles, the inside of a transparent layer can be exhibited, thus realizing a depth feeling of the artificial marbles. In addition, the arrangement of light reflecting materials under the transparent layer by coating or transfer ensures a glittering effect of the inside thereof, thus realizing an excellent appearance, i.e., a light reflection at the inside thereof, which could not be obtained in conventional artificial marbles. In addition, the method for producing the chips utilizes techniques (e.g., casting and pressing) currently used in the art, thus eliminating a necessity of additional equipment. Furthermore, the method of the present invention provides a solution of the difference in specific gravity between the compound of the artificial marble product and chips, i.e., the most important problem involved in the production of an artificial marble. The general methods using a low specific gravity material only such as an acrylic or unsaturated polyester (UPE) resin having a specific gravity lower than that of the compound for artificial marble products make it impossible to obtain a desired pattern. On the other hand, the methods of the present invention allow the specific gravity of the chips to be similar to that of the compound contained in artificial marble products, thereby achieving a desired appearance.

1. High specific gravity light reflecting chips for an artificial marble consisting of a high specific gravity layer, a low specific gravity layer, and a light reflecting layer laminated in this order from the top,
wherein the high specific gravity layer has a specific gravity higher than that of the artificial marble, the low specific gravity layer has a specific gravity lower than that of the artificial marble, and the light reflecting layer contains a light reflective material.

2. The high specific gravity light reflecting chip according to claim 1, wherein the difference in specific gravity between the high specific gravity light reflecting chips and a material composition of the artificial marble using the chips is not more than 0.5.

3. The high specific gravity light reflecting chips according to claim 1, wherein the total specific gravity of the high specific gravity light reflecting chips is in the range of 1.0 to 2.0.

4. The high specific gravity light reflecting chips according to claim 1, wherein the specific gravity of the high specific gravity layer is in the range of 1.5 to 10.

5. The high specific gravity light reflecting chips according to claim 1, wherein the specific gravity of the low specific gravity layer is in the range of 0.1 to 2.0.

6. The high specific gravity light reflecting chips according to claim 1, wherein the low specific gravity layer is a transparent layer having a light transmissivity of 70 to 100%.

7. The high specific gravity light reflecting chips according to claim 1, wherein the high specific gravity layer and the low specific gravity layer comprise a base resin composed of at least one selected from acrylic resin, unsaturated polyester resin, epoxy resin, polyvinyl chloride (PVC), polystyrene (PS), polycarbonate (PC), polyethylene terephthalate (PET), and styrene-methyl methacrylate (SMMA) copolymer.

8. The high specific gravity light reflecting chips according to claim 1, wherein the low specific gravity layer is a transparent layer comprising an acrylic or unsaturated polyester resin as a base resin.

9. The high specific gravity light reflecting chips according to claim 1, wherein the high specific gravity layer comprises a filler having a specific gravity of 2.0 to 10.

10. The high specific gravity light reflecting chips according to claim 9, wherein the filler is at least one selected from barium, precipitated calcium carbonate, stone powders, silica, titanium dioxide, aluminum hydroxide, calcium carbonate, metal powders, and metal salts.

11. The high specific gravity light reflecting chips according to claim 1, wherein the light reflective material is composed of at least one selected from metals, nonmetals, pearls and glass flakes.

12. A method for producing high specific gravity light reflecting chips for an artificial marble, the method comprising steps of:
producing a flat board for a low specific gravity layer having a specific gravity lower than that of the artificial marble;
laminating a flat board for a high specific gravity layer having a specific gravity higher than that of the artificial marble on the flat board for a low specific gravity layer;
laminating a flat board for a light reflecting layer under the flat board for a low specific gravity layer; and
crushing the resulting laminate.

13. The method according to claim 12, wherein the specific gravity of the high specific gravity light reflecting chips is regulated to be equal to, or approach that of a material composition of the artificial marble by regulating the specific gravity and content of a filler to be added to the high specific gravity layer flat board.

14. The method according to claim 12, wherein each flat board is cured by casting, press, vibrator or UV curing.

15. The method according to claim 12, wherein the flat board for a light reflecting layer is formed by transferring or depositing metals on the light reflecting layer.

16. The method according to claim 12, wherein the flat board for a light reflecting layer is formed by adding pearls, glass flakes or a mixture thereof to a resin, and coating the mixture on the light reflecting layer.

17. An artificial marble using the high specific gravity light reflecting chips according to claims 1.

18. The artificial marble according to claim 17, wherein the artificial marble comprising light reflecting transparent chips consisting of a transparent layer to be exposed to the outside from the surface of the artificial marble, and a light reflecting layer arranged under the transparent layer, which are formed by removing the high specific gravity layer by sanding on the low specific gravity layer which is transparent.

19. A method for producing an artificial marble, the method comprising the steps of:
producing a flat board for a transparent layer having a specific gravity lower than that of the artificial marble;
laminating a flat board for a high specific gravity layer having a specific gravity higher than that of the artificial marble on the flat board for a transparent layer;
laminating a flat board for a light reflecting layer under the flat board for a transparent layer;
crushing the resulting laminate to produce high specific gravity light reflecting chips;
producing an artificial marble using the high specific gravity light reflecting chips; and
removing the high specific gravity layer by sanding to allow the transparent layer to be exposed to the outside from the surface of the artificial marble.
